(19) United States
(12) Patent Application Publication
(10) Pub. No.: US 2011/0016062 A1
(43) Pub. Date: Jan. 20, 2011

(54) TAX DEDUCTION APPARATUS AND METHOD

(76) Inventors: William W. Olsen, Payson, UT (US); Matson A. Magleby, Provo, UT (US); Kenneth I. Fox, Orem, UT (US); Morgan A. Magleby, Provo, UT (US)

Correspondence Address: Warren M Pate;WARREN M. PATE, LLC, P.O. Box 9758, Salt Lake City, UT, 84109, US

(21) Appl. No.: 12/836,563

(22) Filed: Jul. 14, 2010

Related U.S. Application Data
(60) Provisional application No. 61/226,159, filed on Jul. 16, 2009.

(51) Int. Cl. G06Q 40/00; G01S 19/39; H04W 4/02

(52) U.S. Cl. 705/36 T; 342/357.22; 715/828; 715/772; 715/764; 455/456.1

(57) ABSTRACT

An apparatus and method providing individuals and small businesses a simple and inexpensive way to collect information regarding their specific situation, identify and maximize available tax benefits, record various financial and non-financial information necessary to support the tax benefits, and systematically work toward growing the business.

### RELATED APPLICATIONS

This application claims the benefit of co-pending U.S. Provisional Patent Application Ser. No. 61/226,159 filed Jul. 16, 2009, which is hereby incorporated by reference.

### BACKGROUND

1. Field of the Invention

This invention relates to an internet-based software application for home-based users to record, log, and otherwise track the information needed to take advantage of available tax strategies, set goals, and track progress toward meeting the goals.

2. Background of the Invention

In the past, the average home-based business did not justify the time and money necessary to explore all the tax deduction strategies available within the applicable tax law (e.g., the Internal Revenue Code). Tax laws typically seek to promote economic growth via favorable tax treatment for entrepreneurs willing to risk time and capital. Lacking a method to tap into and understand the favorable tax treatment, a small business may be at a significant disadvantage. For example, the small business may pay higher taxes, have fewer economic resources upon which to draw, and have a more difficult road to success.

In view of the foregoing, what is needed is an apparatus and method providing a small business a simple and inexpensive way to collect information regarding their specific situation, maximize available tax benefits, and record various financial and non-financial information necessary to support the tax benefits.

### BRIEF SUMMARY OF THE INVENTION

In view of the foregoing, in accordance with the invention as embodied and broadly described herein, a method and apparatus are disclosed in one embodiment of the present invention as including a software system supporting users in their efforts to apply specific tax strategies and grow their business. In selected embodiments, the system may include an interface module, a login module, a set-up module, a data module, a report module, a services module, other modules as desired or necessary, a database, and the like.

An interface module may provide one or more interfaces through which individuals may access the system. One such interface may be configured for users of the system. Another such interface may be configured for tax or accounting professionals. This interface may provide greater functionality in a more traditional, “double entry” accounting format that will be familiar and understandable to the professional.

A login module may identify a user or professional and determine if he is current on his subscription to system. If the user is current, the login module may permit the user to interface with the system. A set-up module may assist a user in characterizing his particular situation and aligning the user with appropriate tax strategies.

A data module may collect information it receives from a user, other sources, or combinations thereof. A data module may also operate on collected information to produce additional information. The information collected, derived, or determined by a data module may include information regarding or characterizing a user's finances, business structure, business phase, calendar, activities, mileage, goals, progress toward goals, contacts, mentors, mentees, employees, retained or hired professionals, prospects, customers, sales, inventory, and the like or combinations or subsets thereof. A data module may store this information within a database for future retrieval.

A report module may generate reports presenting data contained within the system. A services module may offer to a user optional support services related to running a business. For example, a services module may provide an interface between a user and payroll services.

In selected embodiments, a system in accordance with the present invention may provide consolidation and distribution. For example, a business lunch may be considered a business event or activity. The lunch may have expense data associated with it. It may also have associated mileage data. Accordingly, to increase the ease with which a user may document such data, a system may consolidate the various data-entry portals relevant to a particular business event into a single page, single window, single expandable page or, or single progression of pages or windows. Thus, a system providing consolidated data entry in accordance with the present invention may remove from the user much of the burden associated with recording the data required to fully implement the optimized tax strategy.

Once entered, data may be distributed. This distribution may be logical rather than physical. For example, the data may be stored such that it may be easily found via navigation of a high level menu. Accordingly, despite consolidated entry, the stored data may be broken out into specific categories such that any pierce thereof may be found via logical (e.g., categorical or subject-matter based) navigation of the system.

In selected embodiments, a system may provide a method for motivating a user to continue or expand his business-related efforts. The method may begin with a company offering a system in accordance with the present invention to one or more individuals (e.g., one or more of its contractors, distributors, etc.). The individuals may then enter their business and financial data into the system. Using that data, the system may calculate a predicted tax benefit of being in business (e.g., continuing to work with the company). The system may then present the predicted tax benefit to the individual.

When presented with real time or year-to-date predictions of their tax savings based on actual data, individuals may be better positioned to accurately judge the value of their continued business efforts. For example, by comparing their monthly outflow to predicted tax savings, a system may help them see that it may be contrary to their financial interest to quit.

In certain embodiments, a system in accordance with the present invention may provide a method for monitoring and reporting a user's progress toward reaching one or more goals. The method may begin when the system receives data defining one or more goals or modifications to one or more existing goals. The system may then receive data defining an event or activity. After the event or activity, the system may update the user's data-set. Using the updated data, the system may present to a user information indicative of the user's progress toward meeting one or more goals. For example, if a user has established a goal to meet with twenty prospects per month, the system may present to a user a comparison between the user's actual number of meetings with prospects and the corresponding goal of twenty such meetings.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a high-level block diagram of one embodiment of a computer system configured to run software in accordance with the present invention;

FIG. 2 is a high-level block diagram of the design of hardware and software of one embodiment in accordance with the present invention;

FIG. 3 is a diagram of a set-up module in accordance with the present invention;

FIG. 4 is a diagram of a data module in accordance with the present invention;

FIG. 5 is a diagram of a report module including pre-defined reports as well as custom and query reports in accordance with the present invention;

FIG. 6 is a diagram of a services modules offering various add-on services in accordance with the present invention;

FIG. 7 is a diagram of an overall process and information flow in accordance with the present invention;

FIG. 8 is a diagram of one embodiment of a method to motivate a user to continue his business efforts in accordance with the present invention;

FIG. 9 is a diagram of one embodiment of a method of how proprietary relationships with third party banks and financial institutions may facilitate semi-automated, consolidated data entry in accordance with the present invention;

FIG. 10 is a diagram of one embodiment of a method for using a GPS application to facilitate semi-automated, consolidated data entry in accordance with the present invention;

FIG. 11 is a diagram of one embodiment of a method facilitating confirmation of activities (e.g., events, expenses, mileage, etc.) in accordance with the present invention;

FIG. 12 is a diagram of one embodiment of a method enabling users to set business goals, track progress, and present that progress to themselves as well as to one or more third parties in accordance with the present invention;

FIG. 13 is a diagram of one embodiment of a page or window comparing a user's business goals to his actual performance and displaying reporting and accountability connections in accordance with the present invention;

FIG. 14 is a diagram of one embodiment of a page or window enabling users to input their contacts and assign one or more categories characterizing the relationship and a single sales-cycle pool designation in accordance with the present invention;

FIG. 15 is a diagram of one embodiment of a page or window enabling users to follow up with prospects in a manner facilitating reporting and accountability in accordance with the present invention;

FIG. 16 is a diagram of one embodiment of a page or window enabling users to follow up with customers in a manner facilitating reporting and accountability in accordance with the present invention;

FIG. 17 is a diagram of one embodiment of a method for reporting to a user the current phase occupied by the user's business in accordance with the present invention;

FIG. 18 is a diagram of one embodiment of a method for handling billable events in accordance with the present invention;

FIG. 19 is a diagram of one embodiment of a method enabling a sole proprietor to take full advantage of employing a spouse and deducting medical expenses as employee benefits to the spouse in accordance with the present invention; and

FIG. 20 is a diagram of one embodiment of a method enabling professionals (e.g., tax professionals, accounting professionals, etc.) to use a system in accordance with the present invention in support of their clients who are users of the system.

### DETAILED DESCRIPTION OF SELECTED EMBODIMENTS

It will be readily understood that the components of the present invention, as generally described and illustrated in the Figures herein, could be arranged and designed in a wide variety of different configurations. Thus, the following more detailed description of selected embodiments of the invention, as represented in the Figures, is not intended to limit the scope of the invention, but is merely representative of certain examples of presently contemplated embodiments. The presently described embodiments will be best understood by reference to the drawings, wherein like parts are designated by like numerals throughout.

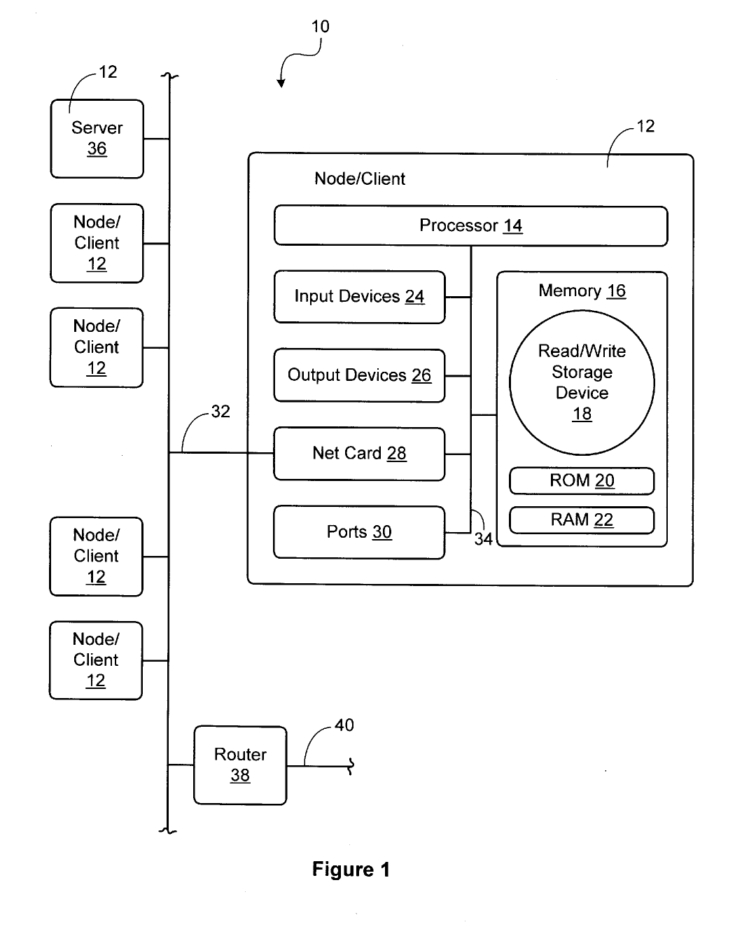

Referring to FIG. 1, the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may each generally be referred to herein as a “module” or “system.”Furthermore, the present invention may take the form of a computer program product embodied in any tangible medium of expression having computer-usable program code embodied in the medium.

Any combination of one or more computer-usable or computer-readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM) device, a read-only memory (ROM) device, an erasable programmable read-only memory (EPROM or Flash memory) device, an optical fiber, a portable compact disc read-only memory (CDROM), an optical storage device, transmission media such as those supporting the Internet or an intranet, or a magnetic storage device.

In certain embodiments, the computer-usable or computer-readable medium may even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in any combination of one or more programming languages, including an object-oriented programming language such as Java, Smalltalk, C++, or the like and conventional procedural programming languages, such as the “C” programming language or similar programming languages. In selected embodiments, the present invention may be at least partially written in a scripting language such as PHP. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Selected embodiments of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions or code. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

In selected embodiments, an apparatus 10 in accordance with the present invention may include one or more nodes 12, computers 12, clients 12, or the like. A node 12 may include a processor 14 or central processing unit (CPU) 14. A node 12 may also include a memory device 16. A memory device 16 may be operably connected to a processor 14 and include one or more devices such as a hard drive 18 or other non-volatile storage device 18, read-only memory (ROM) 20, random access memory (RAM) 22, and the like. These components 14, 16, 18, 20, 22 may exist in a single node 12 or may be distributed across multiple nodes 12.

In selected embodiments, a node 12 may include one or more input devices 24 such as a keyboard, mouse, touch screen, scanner, memory device, communication line, and the like. A node 12 may also include one or more output devices 26 such as a monitor, printer, memory device, and the like. A node 12 may further include a network card 28, port 30, or the like to facilitate communication through a network 32. Internally, one or more busses 34 may operably interconnect the various components 14, 16, 24, 26, 28, 30 of a node 12 to provide communication therebetween. Each node 12 of an apparatus 10 may contain more or less of the components described hereinabove.

An apparatus 10 may further include one or more servers 36 and the like to serve files, data, applications, etc. to nodes 12 connected thereto. An apparatus 10 may also include one or more routers 38 and the like. Accordingly, one network 32 may be connected to other networks 40 via one or more routers 38.

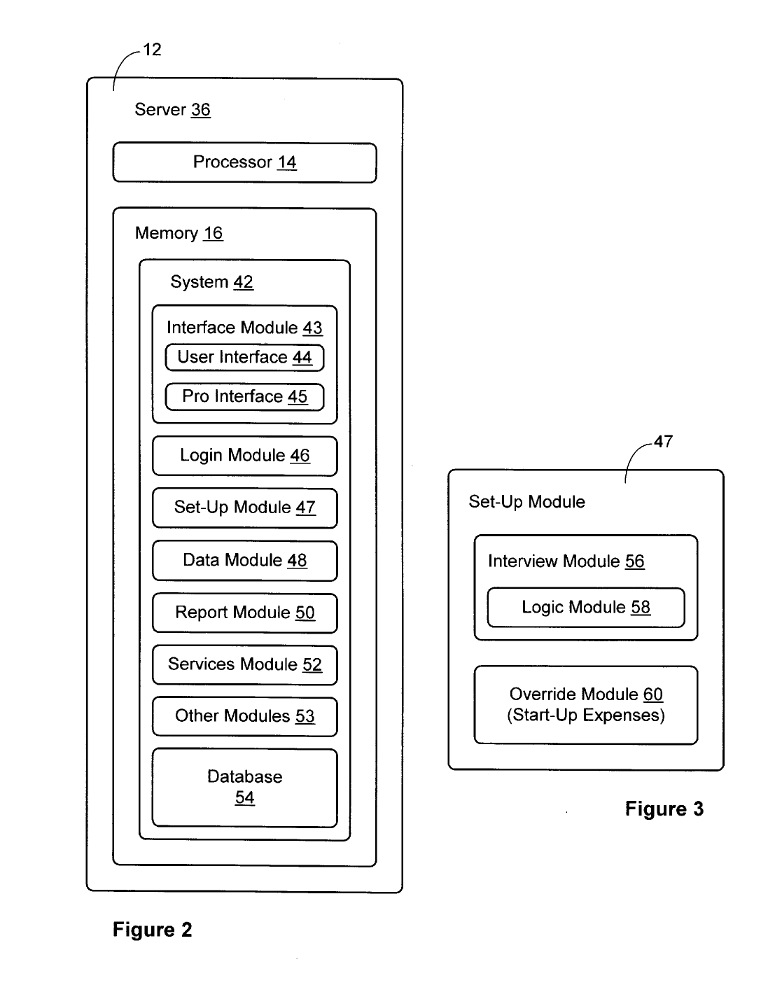

Referring to FIG. 2, a software system 42, software product 42, or application 42 in accordance with the present invention may be installed locally on a computer 12 corresponding to a particular user. Alternatively, a system 42 may be installed remotely on one or more servers 34. In still other embodiments, a system 42 may have one or more portions installed locally and one or more portions installed remotely. In any such embodiment, the data (e.g., data-set, account data, or the like) corresponding to a particular user may be stored locally, remotely, or some combination thereof.

In selected embodiments, a system 42 may include an interface module 41, a login module 46, a set-up module 47, a data module 48, a report module 50, a services module 52, other modules 53 as desired or necessary, a database 54, and the like. An interface module 43 may provide one or more interfaces 44, 45 through which individuals may access the system 42. In selected embodiments, an interface module 43 may provide at least two interfaces 44, 45. One such interface 44 may be configured for users (e.g., business owners or prospective business owners) of the system 42. Such an interface may be designed for simplicity and ease of use by the average business person. Accordingly, the interface 44 may not overwhelm the user with excessive functionality and complexity. The other such interface 45 may be configured for professionals (e.g., tax professional, accounting professional). This interface 45 may provide greater functionality in a more traditional, “double entry” accounting format that will be familiar and understandable to the professional.

An interface module 43 may interface with an individual (e.g., user or professional) in any suitable manner. In selected embodiments, a system 42 may interface with an individual via a software application (e.g., a web browser, dedicated application, or the like) running on the individual's computer, mobile application running on a portable device (e.g., cellular telephone, personal digital assistant (PDA), or the like), pop-up windows, email messages, and the like or various combinations thereof.

A login module 46 may identify a user or professional and determine if he is current on his subscription to system 42. If the user is current, the login module 46 may permit the user to interface with the system 42. A set-up module 47 may assist a user in characterizing his particular situation and aligning the user with appropriate tax strategies. A data module 48 may collect information it receives from a user, other sources, or combinations thereof. A data module 48 may also operate on collected information to produce additional information (e.g., calculations, predictions, etc.).

The information collected, derived, or determined by a data module 48 may include information regarding or characterizing a user's finances, business structure, business phase, calendar, activities, mileage, goals, progress toward goals, contacts, mentors, mentees, employees, retained or hired professionals, prospects, customers, sales, inventory, and the like or combinations or subsets thereof. A data module 48 may store this information within a database 54 for future retrieval.

A report module 50 may generate reports presenting data contained within the system 42. A report module 50 may generate various predefined reports. A report module 50 may also generate reports based on queries and particular, user-selected sorting. A report module 50 may provide to a user real-time estimates on the year-to-date effectiveness of the tax strategies being implemented. A services module 52 may offer to a user optional support services related to running a business. For example, a services module 52 may provide an interface between a user and payroll services.

Referring to FIG. 3, a set-up module 47 may identify for a user the best tax strategies available for that particular user. A set-up module 47 may also educate a user on important aspects of using the system 42 to pursue or follow those tax strategies. In selected embodiments, this may be accomplished via a simulated or virtual interview with a tax professional. An interview module 56 may be responsible for conducting the interview with the user.

An interview module 56 may apply or follow different paths, depending on the answers provided by a user. In certain embodiments, an interview module 56 may begin an interview with a brief description of how the system 42 uses specific strategies. The interview module 56 may then ask a user a series of questions. A logic module 58 may simulate the decision process a tax professional would pursue in determining which follow-up questions to ask. The end result of an interview may be a recommended business and tax strategy tailored to the particular situation and goals of the user.

In selected embodiments, a set-up module 47 may include an override module 60. An override module 60 may ensure adherence to the applicable laws, overriding manual inputs as necessary. For example, if a user enters expenses dated prior to the official business start date, the system 42 may ensure that such expenses are categorized as “start-up” expense. This categorization may in turn ensure that a tax professional preparing a tax return for the user will treat the expenses properly.

An override module 60 may ensure adherence to the applicable laws after the initial set-up of the system 42 has been completed for a particular user. For example, if a user attempts to pay a wage to a child beyond the child's eighteenth birthday, an override module 60 may prevent it, thus maintaining the integrity of the particular tax strategy.

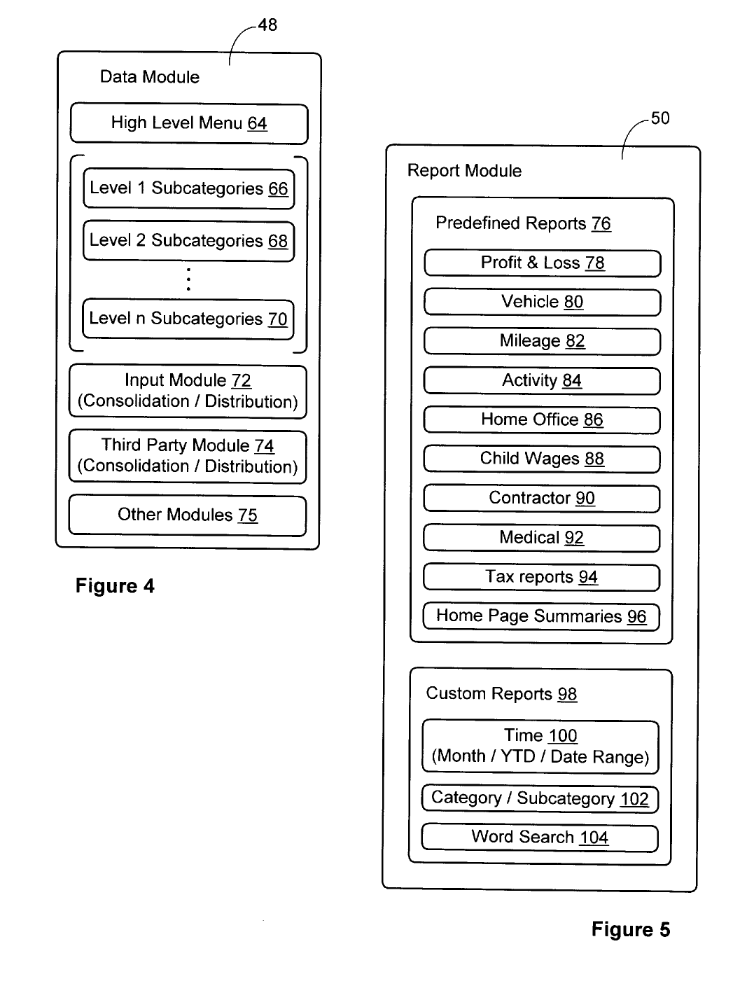

Referring to FIG. 4, a data module 48 and any of its included sub-modules (e.g., input module 72, third party module 74, or other modules 75 as desired or necessary) may facilitate the process of entering data into the system 42. In selected embodiments, a data module 48, an interface module 43, or both modules 48, 43 working together may provide a hierarchy of menus accessible to a user upon logging into the system 42.

For example, immediately upon logging into the system 42, a user may be presented with one or more high level menus 64 identifying the primary functions or data groups offered by the system 42. In one embodiment, a high level menu 64 may comprise an array of tabs, with each tab corresponding to a “page” dedicated to a different item on the high level menu 64. In selected embodiments, one high level menu 64 may include home, expense, income, mileage, activity, contacts, learn, and reports pages.

Upon selecting an item on the high level menu 64, a user may be presented with a first level of subcategories 66 from which to choose. For example, selection of “home” from a high level menu 64 may lead to a first level of subcategories 66 including “record income,” “track expenses,” “log mileage,” “track time and activity,” “deduct samples,” and/or “plan for tomorrow.” Selection of a particular first level subcategory may lead a user to certain data-entry portals or on to a second level of subcategories 68. Other levels of subcategories 70 may be provided as necessary, depending on the granularity desired. Similarly, selected levels 64, 66, 68, 70 may be omitted as desired or necessary. Accordingly, a data module 48, an interface module 43, or both modules 48, 43 working together may guide a user from broad categories down through more specific categories to ensure that the user is easily able to pinpoint the optimal category (e.g., the optimal category for a particular expense).

In selected embodiments, a data module 48, an interface module 43, or both modules 48, 43 working together may provide consolidation and distribution in accordance with the present invention. A business event or activity may have various types of data associated therewith. Maximization of the benefit a user receives from such a business event or activity may depend on the ease with which the user can accurately record all of those various types of data. Consolidation and distribution in accordance with the present invention may significantly increase that ease.

For example, a business lunch may be considered a business event or activity. The lunch may have a monetary expenditure associated with it. It may also have associated mileage data. However, to fully document the event in compliance with tax laws, more than mere expense and mileage data may be necessary. For example, it may be necessary to document, the date, purpose, etc. of the business event. Accordingly, to increase the ease with which a user may documents such data, a data module 48, an interface module 43, or both modules 48, 43 working together may consolidate the various data-entry portals relevant to a particular business event into a single page, single window, single expandable page or window (e.g., a page or window that expands or contracts to display more or fewer data-entry portals in accordance with selections of a user on the page or window), or single progression of pages or windows.

For example, for a business lunch, a user interface module 43 and an input module 72 may cooperate to present to a user, at the same time and within a single page, single window, or single expandable page or window, all of the relevant data-entry portals for such an event. Such portals may include one or more portals for each of form of tender (i.e., whether tender was made by check/debit, charge, or cash), check number, account drawn upon, expense type, expense category, expense subcategory, date of expense, payee, expense amount, description of purpose of event, number of miles driven, end odometer reading, activity start time, activity stop time, activity category, etc. Based on the nature of the event, activity, or expense being documented, one or more of the particular data-entry portals listed may be removed from the page or window, one or more other data-entry portals may be added to the page or window, etc.

Thus, through a single entry page, window, or progression, a user may enter the expense information from a receipt for the lunch (i.e., the when, where, and how much), the who and why (i.e., the business purpose) of the expense, the number of miles driven, as well as the time associated with the lunch (i.e., to create an activity entry). In such an embodiment, the user need not sequentially navigate to an expense page and enter expense data, then navigate to a mileage page and enter mileage data, and then navigate to an activity page and log time spent. Moreover, in such an embodiment, the user need not remember all of the data he should be recording to fully implement the optimized tax strategy. Accordingly, a system 42 providing consolidated data entry in accordance with the present invention may remove from the user much of the burden associated with recording the data required to fully implement the optimized tax strategy.

Once entered, data may be distributed by a data module 48, or any of its included sub-modules, within the system 42. This distribution may be more logical than physical. For example, in certain embodiments, the data may be stored (e.g., in a database 54) such that it may be easily found via navigation of a high level menu 64. That is, the expense data may be stored such that selection of an “expenses” tab may lead a user to a list of expenses entries that includes the particular expense data. Similarly, the mileage data may be stored such that selection of a “mileage” tab may lead a user to a list of mileage entries that includes the particular mileage data, etc.

In selected embodiments, a third party module 74 may receive data from third parties. For example, a third party module 74 may electronically receive expense information from a bank or other financial institution. Similarly, a third party module 74 may receive global positioning system (GPS) information from a GPS application associated with a user (e.g., carried on the user's person, traveling in the user's vehicle, etc.). A third party module 74 may use the information it receives to further lighten the burden of recording the data required to fully implement the optimized tax strategy.

For example, a third party module 74 may process (e.g., filter) the information it receives to facilitate data entry into a system 42. In certain embodiments, this may include extracting date, time, amount, and payee information from a bank transaction. In other embodiments, it may include extracting date, time, and miles traveled from information provided by a GPS application running on the user's cellular telephone, PDA, hardware associated with the user's car, or the like. In still other embodiments, it may include comparing information received from one party (e.g., a financial institution) with information received from another third party (e.g., an application running on the user's cellular telephone) to identify patterns or links (e.g., proximities in time, space, etc.) therebetween.

Once the information has been received and processed, a third party module 74, an interface module 43, or both modules 78, 43 working together may present the information to the corresponding user. In selected embodiments, the information may be presented to the user in the form of one or more prefilled data-entry portals. For example, a data-entry page or window may be presented to the user with the data-entry portals for the date, payee, and amount already filled with information received from a third party. Alternatively, a data-entry page or window may be presented to the user with the data-entry portals for the date and mileage already filled with information received from a third party.

In certain embodiments, a third party module 74 may recognize a proximity in time, space, etc. between information received from multiple third parties. For example, a third party module 74 may recognize that certain mileage was traveled within a certain time window of a particular charged payment. In such a situation, the third party module 74 may predict that the mileage traveled and the expense charged are related to the same business event. Accordingly, the third party module 74, the interface module 43, or both modules 78, 43 working together may present a data-entry page or window to the corresponding user with the data-entry portals for the date, payee, amount, duration of activity or event, mileage, etc. traveled already filled with information received from the various contributing third parties.

When presented with prefilled data-entry portals, a user may accept, reject, or modify the data contained within those portals. Accordingly, a user need not be bound to the processing, filtering, or predictions of a third party module 74. However, to the extent that a third party module 74 processes, filters, and predicts accurately, the third party module 74 may further facilitate data entry into a system 42.

Referring to FIG. 5, a report module 50 may make data contained within a system 42 available to one or more users. In selected embodiments, a report module 50 may be configured to generate various predefined reports 76. Certain of the predefined reports 76 may include estimated or calculated information giving a user real-time, year-to-date feedback regarding his status. Such reports may include a profit and loss report 78, vehicle report 80, and home office report 86 (e.g., a report showing the tax savings associated with home office use and expenses).

Other predefined reports 76 may simply present summaries, details, and the like of information stored within the system 42. Such reports may include a mileage report 82, activity report 84, child wages report 88, contractor report 90 showing funds paid to one or more contractors, medical report 92 showing medical expenses, one or more tax reports 94 showing tax related data in summarized form, and the like.

In certain embodiments, a report module 50 may populate portions of one or more pages with various summaries, details, estimations, predictions, or calculations derived from the data stored within a system 42. For example, a report module 50 may generate one or more home page summaries 96 (i.e., information having sufficient utility to merit presentation on a home page of the system 42). In selected embodiments, the home page summaries 96 may provide a user with instant feedback regarding his overall estimated tax savings, numbers relative to often overlooked tax deductions, numbers characterizing the hours spent by the user, and the like. In certain embodiments, these summaries 96 may be the culmination of a series of estimates and calculations based on the data of one or more predefined reports 76.

In selected embodiments, a report module 50 may provide to a user the ability to generate one or more custom reports 98. For example, a report module 50 may enable a user to generate reports 100 based on various time delineations, reports 102 based on certain selected categories or subcategories, reports 104 based on word searches, and the like. Accordingly, a report module 50 may support certain ad hoc functionality making data stored within the system 42 accessible to a corresponding user.

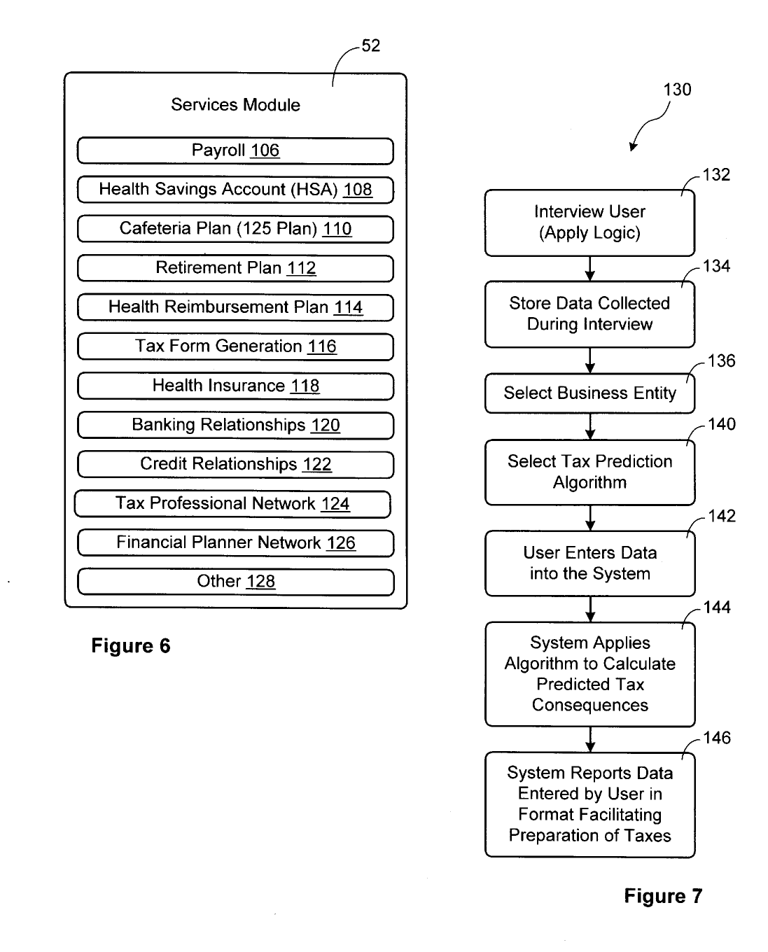

Referring to FIG. 6, a services module 52 may provide an interface between a user and one or more services supporting the user. In selected embodiments, the services may comprise add-on features that use information stored within the system 42 to provide greater or expanded utility to the user. For example, a services module 52 may provide an interface between a user and one or more payroll services or systems 106, tax form generation services or systems 116 providing or facilitating periodic tax return filings, and the like.

In certain embodiments, a services module 52 may enable a user to establish relationships that may be important to the success of the user's business. For example, a services module 52 may assist a user in establishing banking relationships 120, credit relationships 122, and the like.

Other services offered or facilitated by a services module 52 may include those associated with benefits for the owners and employees of a business. Accordingly, in selected embodiments, a services module 52 may provide an interface between a user and one or more health savings accounts or account providers 108, cafeteria plans or plan providers 110, retirement plans or plan providers 112, health reimbursement plan or plan providers 114, health insurance policies or policy providers 118, tax professionals or professional network 124, financial planners or planner network 126, and the like.

A services module 52 may guide a user through a process for obtaining the desired services. Alternatively, or in addition thereto, a services module 52 may provide to a user one or more referrals to persons or businesses providing the desired services. Accordingly, a services module 52 may generate revenue by marketing and providing services, referring services to others, or some combination thereof.

Referring to FIG. 7, in selected embodiments, an overall flow 130 of information through a system 42 in accordance with the present invention may begin with conducting 132 an interview of a user. This interview may comprise audible questions, legible questions, or some combination thereof presented to a user.

As the user answers the questions, the system 42 may store 134 any or all of the data collected and narrow the options available to the user. Accordingly, the system 42 may eventually select 136 or identify 136 a business entity that may best meet the needs and goals of the user. Additionally, based on the data collected during the interview, the system 42 may select 140 or identify 140 a tax prediction algorithm to be implemented for the user.

The tax prediction algorithm for a particular user may define what data the system 42 will need from the user and what calculations will need to be made in predicting the user's present tax status. That is, certain categories of information can be applied differently between users depending on the tax prediction algorithm corresponding thereto.

For example, under current U.S. tax law, if a particular user is to operate as a sole proprietorship, the manner of handling personal medical expenses for that user will be different from another user who is to operate as a C-corporation with a health reimbursement plan in place. The former may only be able to deduct the medical expenses on a “Schedule A” subject to 7.5 percent of adjusted gross income (AGI), while the latter may be able to deduct medical expenses from the business as employee benefits. Subsequently, as a user enters 142 data into the system 42, the system 42 may continually apply the selected 140 tax prediction algorithm to calculate 144 the predicted tax consequences as real time or year-to-date numbers. These predicted tax consequences may be reported to a user in any suitable manner. Ultimately, the system 42 may report 146 to a user or other entity (e.g., the user's tax professional) the data entered by user. The data may be reported 146 in a form a tax preparer may use to minimize the user's tax liability, tax preparation costs (e.g., cost of preparing and filing a tax return), and the like.

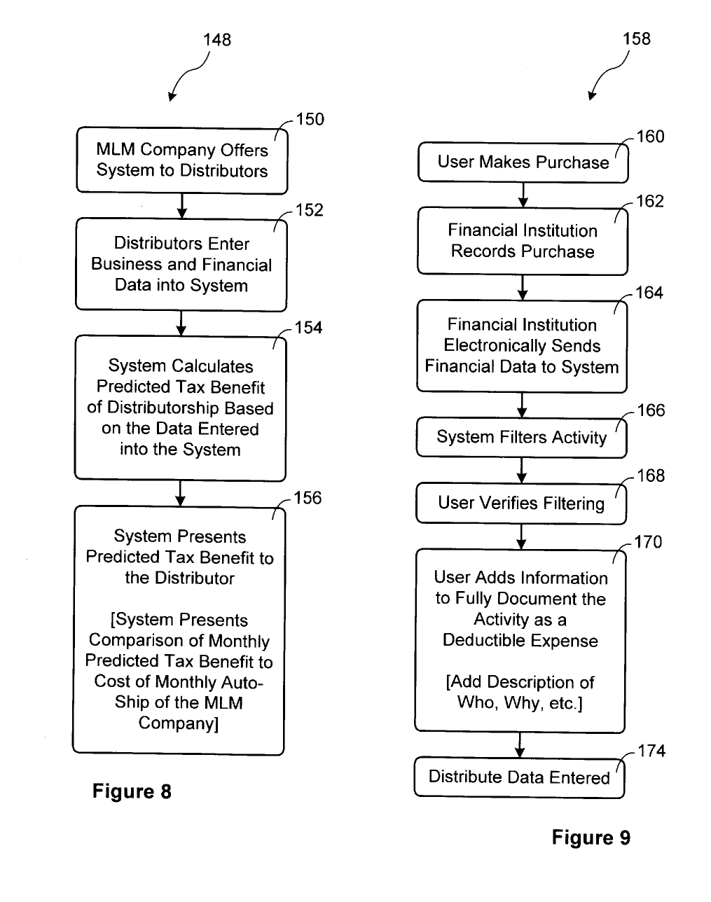

Referring to FIG. 8, in selected embodiments, a system 42 may provide a method 148 for motivating a user to continue or expand his business-related efforts. Various parties may be interested in providing such motivation. For example, the user himself may be looking for self motivation. Alternatively, an entity working with a particular user may be interested in providing increased motivation for that user.

One entity interested in such motivation may be a company employing multi-level-marketing (MLM). An MLM company may be looking to motivate its distributors to perform closer to their potential. Accordingly, in certain embodiments, a system 42 may provide a method 148 to motivate MLM distributors. While this method 148 will be discussed below in the context of MLM companies, it is not limited to such companies and may be used by other individuals or entities looking to motivate themselves or others.

In selected embodiments, an MLM company may offer 150 a system 42 in accordance with the present invention to one or more of its distributors. The distributors may then enter 152 their business and financial data into the system 42. Using that data, the system 42 may calculate 154 the predicted tax benefit of the distributorship. The system 42 may then present 156 the predicted tax benefit to the distributor.

A typical MLM distributor may be an individual looking to develop an income stream. To start an MLM distributorship, a distributor may incur a relatively small startup expenditure, typically on the order of between $100 and $600. Additionally, there is often a required monthly minimum product order (i.e., an “auto-ship”), typically on the order of between $100 and $150 a month. With such expenditures, a distributor unable to generate significant revenue from the onset may find it difficult to keep going and stay at it long enough to see success.

However, when presented with real time or year-to-date predictions of their tax savings based on actual data, distributors may be better positioned to accurately judge the value of their distributorship. For example, by comparing their monthly outflow (e.g., cost of required monthly product order) to predicted tax savings, a system 42 may help them see that it may be contrary to their financial interest to quit.

In certain embodiments, a comparison between predicted tax savings and expenditures necessary to stay in business (e.g., cost of required monthly minimum product order) may be presented as a home page summary 96. For example, a home page summary 96 may include an image graphically comparing the two amounts. Accordingly, every time a user logs into the system 42, he may be instantaneously reminded of an important benefit of staying in business.

A system 42 in accordance with the present invention may take steps to assist a user in properly interpreting and understanding a predicted tax savings. For example, tax savings may depend on the current phase of the user's business. That is, a business may be in one of three phases, namely the startup phase, the momentum phase, or the builder phase. In the startup phase, the business has only expenses and no revenue. In the momentum phase, the business has earned its first dollar, but still has expenses that exceed the income. Finally, in the builder phase, the business has more income than expenses and is making a net profit.

In each of the startup and momentum phases, the user may only realize the full “tax savings” if the user has sufficient taxable income from some other source against which the tax savings (e.g., the documented deductions or losses) may be applied. Conversely, in the builder phase, the user can realize the tax savings within the business, but will also be accruing a tax liability. Accordingly, the language, illustrations, etc. used by a system 42 to describe or quantify a predicted tax savings may change as the business of a user moves from one phases to another.

Referring to FIG. 9, in selected embodiments, a system 42 may provide a method 158 to facilitate data entry. This method 158 may begin when a user makes 160 a purchase. This purchase may include payment by debit card, credit card, check, or the like. Accordingly, as it processes the payment, a financial institution may record 162 data characterizing the purchase. Additionally, the financial institution may communicate 164 data characterizing the purchase to a system 42 (e.g., third party module 74) in accordance with the present invention.

Once the data is communicated 164, the system 42 may filter 166 or otherwise process 166 the data to decide how the data should be handled by the system 42. Such filtering 166 may include checking to see if the data has already been entered into the system 42. Filtering 166 may also include identifying a predicted categorization of the data. In selected embodiments, the system 42 may present this prediction to the user. Accordingly, the user may verify 168 the filtering, making corrections or deletions as necessary to ensure the accuracy of the data to be stored. Additionally, the user may add 170 information (e.g., information characterizing purpose, identifying mileage, identifying time spent, etc.) as necessary to fully document the corresponding activity.

In selected embodiments, the verification 168 of data, addition 170 of data, or both may be performed using consolidated data entry in accordance with the present invention as described hereinabove. That is, a system 42 may consolidate the various data-entry portals relevant to the verification 168, addition 170, or both into a single page, single window, single expandable page or window, or single progression of pages or windows. Such consolidated data entry may provide a multi-dimensional view of an activity or event, not a mere data-entry portal of a single dimension. Accordingly, the method 158 may enable a user to document a business related activity or event once, in one place or series of places, extracting the maximum benefit (e.g., tax benefit) with minimal effort.

After the data is verified 168 and expanded 170 as desired or necessary, the system 42 may distribute 174 the data within the system 42. Accordingly, the data may be stored (e.g., in a database 54) such that it may be easily found via navigation of the system 42. Said another way, the data may be linked to the various parts of the system 42 so all elements of the data are tracked properly for the appropriate reporting of all business related information and activity.

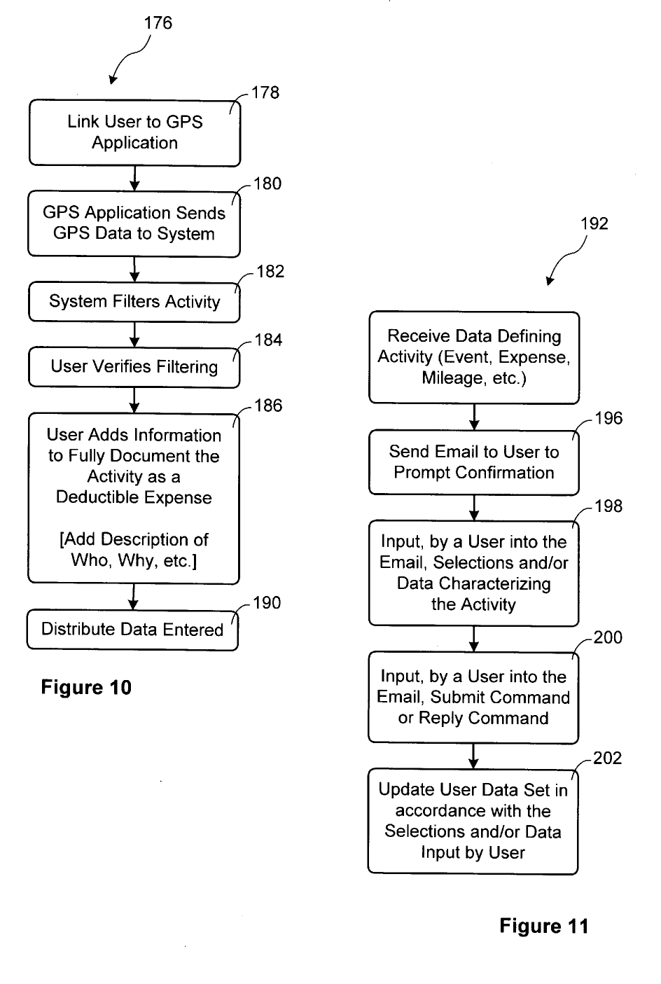

Referring to FIG. 10, in selected embodiments, a system 42 may provide another method 176 to facilitate data entry. This method 176 may begin when a user is linked 178 to a GPS application. Such linking 178 may include installing a GPS application on a cellular telephone carried on the person of the user. Alternatively, linking 178 may include installing a GPS application on a PDA carried on the person of the user, installing a GPS application on hardware associated with the user's vehicle, or the like.

Once installed, a GPS application may send 180 GPS data to a system 42 (e.g., third party module 74). This GPS data may be processed 182 or filtered 182 by the system 42. In selected embodiments, this processing 182 may include breaking down the daily movements or travels of the user into components or segments. Processing 182 may also include predicting which segments may correspond to business activity.

Upon completion of the processing 182, one or more of these segments may be presented by the system 42 to the corresponding user. The user may then verify 184 which of the presented segments are business related and which are not. The user may also add 186 or enter 186 additional information (e.g., information characterizing purpose, related purchases, etc.) as necessary to fully document the corresponding activity.

In selected embodiments, the verification 184 of data, addition 186 of data, or both may be performed using consolidated data entry in accordance with the present invention as described hereinabove. After the data is verified 184 and expanded 186 as desired or necessary, the system 42 may distribute 190 the data within the system 42 so that it may be easily found via navigation of the system 42.

Referring to FIG. 11, in selected embodiments, a system 42 may provide a method 192 for a user to interface with the system 42. This method 192 may enable a user to interface with the system 42 without the user being required to log onto or connect with the system. In selected embodiments, this interface may be accomplished via text messaging, email, etc.

To begin, a system 42 may receive 194 data defining an activity such as an appointment, an expense, mileage traveled, etc. The system 42 may receive 194 this data from a corresponding user or from a third party. Additionally, the system 42 may receive 194 the data before or after the activity takes place.

After the time of the event has passed, the system 42 may initiate 196 contact with the user to prompt the user to confirm the activity. This may be done by launching a pop-up window, sending a text message, sending an email message, or the like. In the illustrated embodiment, the contact is initiated 196 with an email message.

In accordance with the principles of consolidated data entry disclosed hereinabove, the message (e.g., email message) may prompt a user to input 198 information characterizing the activity. This may include deleting, modifying, or adding to certain information contained within the message. When the activity was scheduled within the system 42 before the time of the activity, this may also include confirming whether the activity actually took place.

When the user has entered the necessary or desired information, the user may input 200 a command communicating that information to the system 42. For example, the user may select 200 a “submit” command or button. Alternatively, the user may simply select 200 a “reply” or “send” command. The system 42 may then update 202 the user's data-set (i.e., the data within the system 42 that corresponds to the user or is linked to the user's account) by distribution as disclosed hereinabove.

In one exemplary embodiment, the method 192 may progress in the following manner. A user may have a GPS application installed and running on his cellular telephone as travels from his office to a restaurant to meet a client. The user may pay for the meal using a business credit card, then return with the cellular telephone to his office. The system may receive 194 and process information from the financial institution corresponding to the credit card and from the GPS application.

The next morning, the user may receive 196 an automatic email from the system 42 presenting several pieces of financial, mileage, and time data for verification. Applying its logic, the system 42 may have predicted that the expense, mileage, and time data corresponding to a “meals and entertainment” expense. Accordingly, the financial and mileage data may be presented as a “meals and entertainment” consolidated data-entry form. Thus, the user may simply add 198 to the consolidated data-entry-form the business purpose of the meal, make any corrections deemed necessary, and submit 200 or return 200 the consolidated data-entry form to the system 42. The system 42 may then update 202 the user's data-set by distribution as disclosed hereinabove.

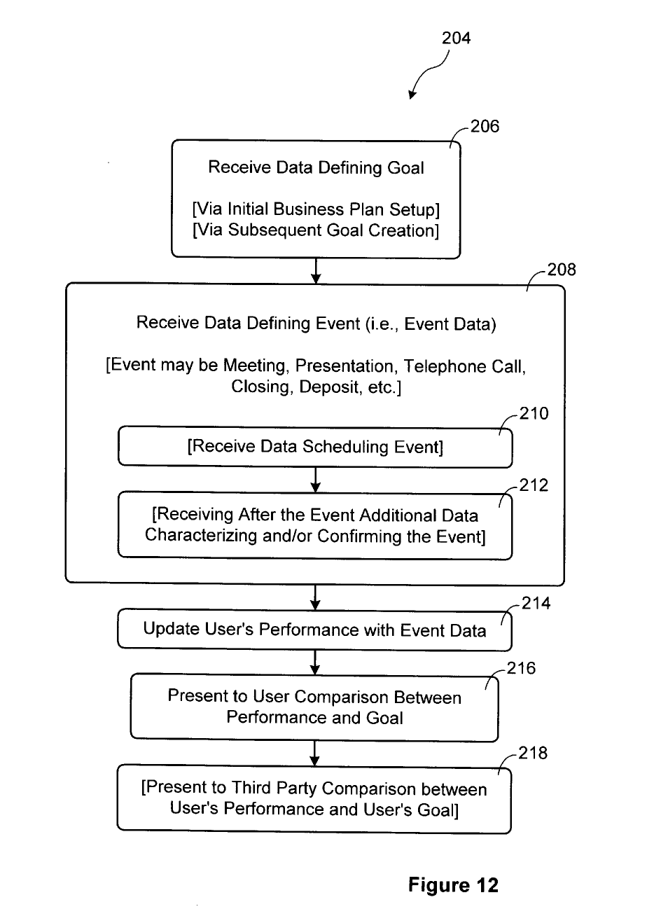

Referring to FIG. 12, in selected embodiments, a system 42 may provide a method 204 for monitoring and reporting a user's progress toward reaching one or more goals. The method 204 may begin when the system 42 receives 206 data defining one or more goals or modifications to one or more existing goals. The system 42 may receive 206 a goal or goal modification via an initial business plan set-up (e.g., through the work of a set-up module 47) or a subsequent goal creation process (e.g., through inputs received by a data module 48).

The system 42 may then receive 208 data defining an event or activity. Suitable events may include meetings, telephone calls, presentations, and the like. In selected embodiments, receiving 208 data defining an event may include (a) receiving 210 beforehand data scheduling an activity such as an appointment and/or (b) receiving 212, from a user after the activity, data confirming, verify, or further explaining the activity.

After the event or activity, the system 42 may update 214 the user's data-set by distribution as disclosed hereinabove. Using the updated 214 data, the system 42 may present 216 to a user information indicative of the user's progress toward meeting one or more goals. The system 42 may present 216 to a user a comparison between the user's actual performance and a goal associated therewithin. For example, if a user has established a goal to meet with twenty prospects (e.g., prospective customers) per month, the system 42 may present 216 to a user a comparison between the user's actual number of meetings with prospects and the corresponding goal of twenty such meetings.

In certain embodiments, a user may elect to share his progress or performance with a third party. This may be desirable to increase the accountability of the user in meeting his goals. Accordingly, a system 42 may communicate 218 or present 218 to a designated third party information indicative of the user's progress toward meeting one or more goals. For example, a system 42 may send an email message to a designated third party providing 218 a comparison between the user's actual performance and a goal associated therewithin.

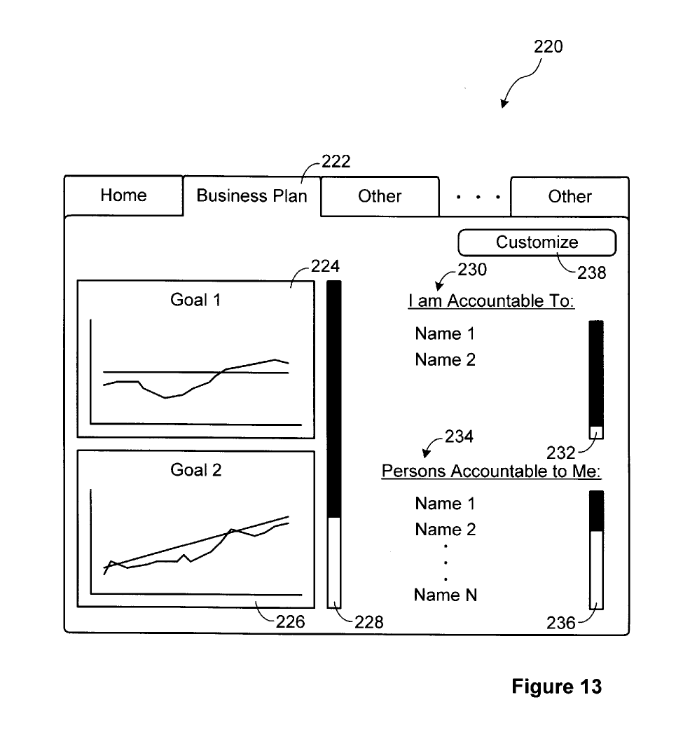

Referring to FIG. 13, in selected embodiments, one or more high level menus 64 or subsequent levels of subcategories 66, 68, 70 may comprise a link 222 or tab 222 taking a user to a page 220 or window 220 displaying various aspects of the user's business plan. For example, in certain embodiments, a link 222 or tab 222 may take a user to a page 220 displaying graphs 224, 226 comparing the user's goals to actual performance. A scroll bar 228 or the like may be included to enable a user to view additional graphs (e.g., graphs for each of the user's active goals).

The page 220 may also display one or more lists 230, 234 of individuals. One list 230 may contain persons to whom the user is accountable (e.g., mentors or persons having access to the user's graphs 224, 226 or the like). Another list 234 may contain persons that are accountable to the user (e.g., mentees or persons whose graphs 224, 226 or the like the user may access). In selected embodiments, selection of a person in the latter list 234 may result in that person's graphs 224, 226 being displayed on the page 220. The various lists 230, 234 may include scroll bars 232, 236 or the like to enable a user to view all portions of any list 230, 234 longer than the allotted or available space.

In selected embodiments, the page 220 may be customizable by a user. For example, a page 220 may include a button 238 that, when selected, launches functionality permitting a user to specify which goals are to be displayed in the graphs 224, 226, which individuals are contained in the lists 230, 234, and the like.

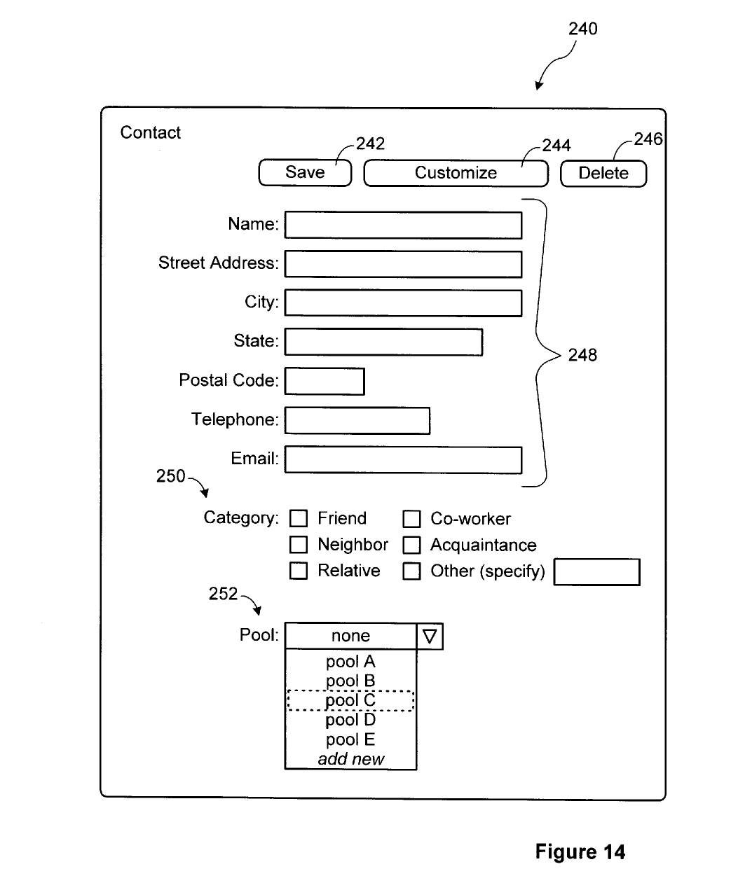

Referring to FIG. 14, in selected embodiments, one or more high level menus 64 or subsequent levels of subcategories 66, 68, 70 may comprise a link or tab taking a user to a page 240 or window 240 comprising data-entry portals relating to a contact. In selected embodiments, the page 240 may include a save button 242 permitting a user to save a new contact or save changes to an existing contact, a customization button 244 permitting a user to customize the data-entry portals (e.g., the input fields), a delete button 246 permitting a user to delete a contact, and the like.

The page 240 may include a collection 248 of data-entry portals or input fields for receiving data such as name, address, and the like. The page 240 may include a collection 250 of contact categories. A user may select whichever (i.e., one or more) of the categories best describe the contact, the user's relationship with the contact, etc. The page 240 may also include a data-entry portal 252 enabling a user to select a “pool” designation for the contact. In selected embodiments, a contact may only have one pool designation 252. The pool designation 252 may support tracking of the contact during the sales cycle, tracking of activities, reporting of activities, and the like.

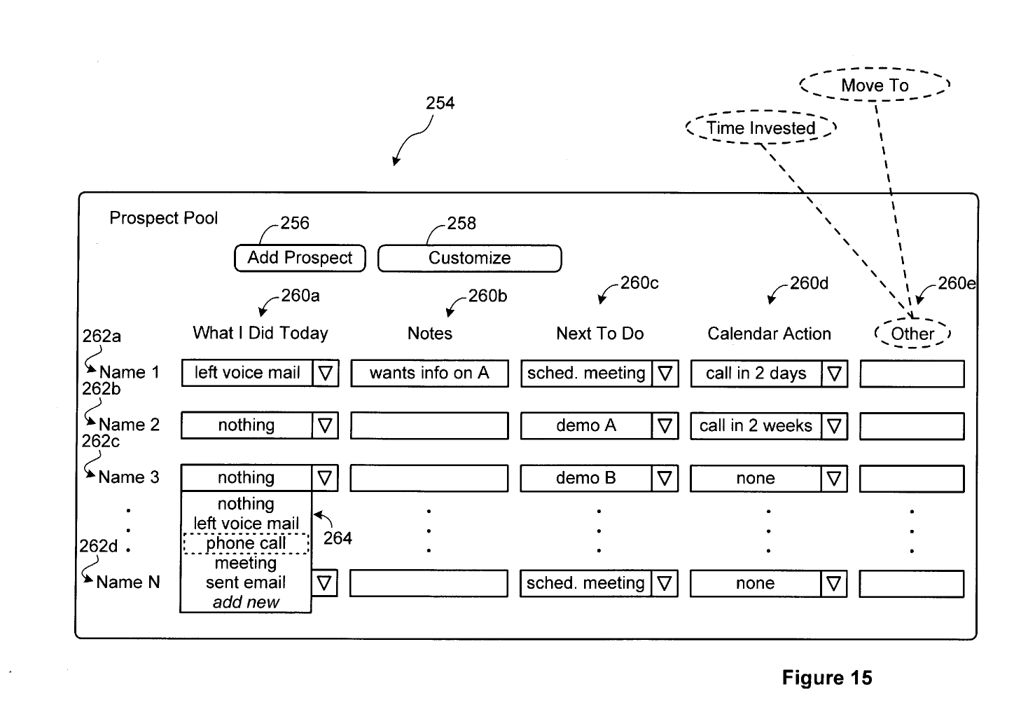

Referring to FIG. 15, in selected embodiments, one or more high level menus 64 or subsequent levels of subcategories 66, 68, 70 may comprise a link or tab taking a user to a page 254 or window 254 comprising data-entry portals relating to a prospect pool. This page 254 may provide a mechanism for a user to track prospects, plan activities involving specific prospects, and work systematically to move individuals from the prospect pool into a customer pool

In certain embodiments, the page 254 may include a button 256 to add an individual to the pool, a button 258 to customize the page 254 (e.g., customize the column headings, select which columns to display, etc.), and the like. In selected embodiments, the page 254 may display, for each prospect listed 262a, 262b, 262c, etc. various pieces of information 260a, 260b, 260c, etc.

For example, the page 254 may list information regarding what the user did today 260a with respect to the prospect, notes 260b, what the user plans to do next 260c with respect to the prospect, the date 260d when the next action is to be taken, and the like. Other information 260e that may be included within the page 254 may be a running total of the time invested in the prospect, an input field enabling the user to move the prospect into another pool (e.g., a customer pool), and the like.

In selected embodiments, when a date 260d for a next action 260c is selected, the system 42 may appropriately schedule that action 260c on the user's calendar within the system 42 (e.g., add the action 260c and date 260d to the user's data-set). Accordingly, the system 42 may verify whether the action 260c takes place. This may be done using a verification method 192 in accordance with the present invention.

Selected pieces of information (e.g., notes 260b) displayed for a prospect may be entered or changed by a user as free form text. Other pieces of information (e.g., “What I did Today” 260a) displayed for a prospect may be selected or changed using a menu of predefined options, thereby increasing the rate at which data is entered or updated.

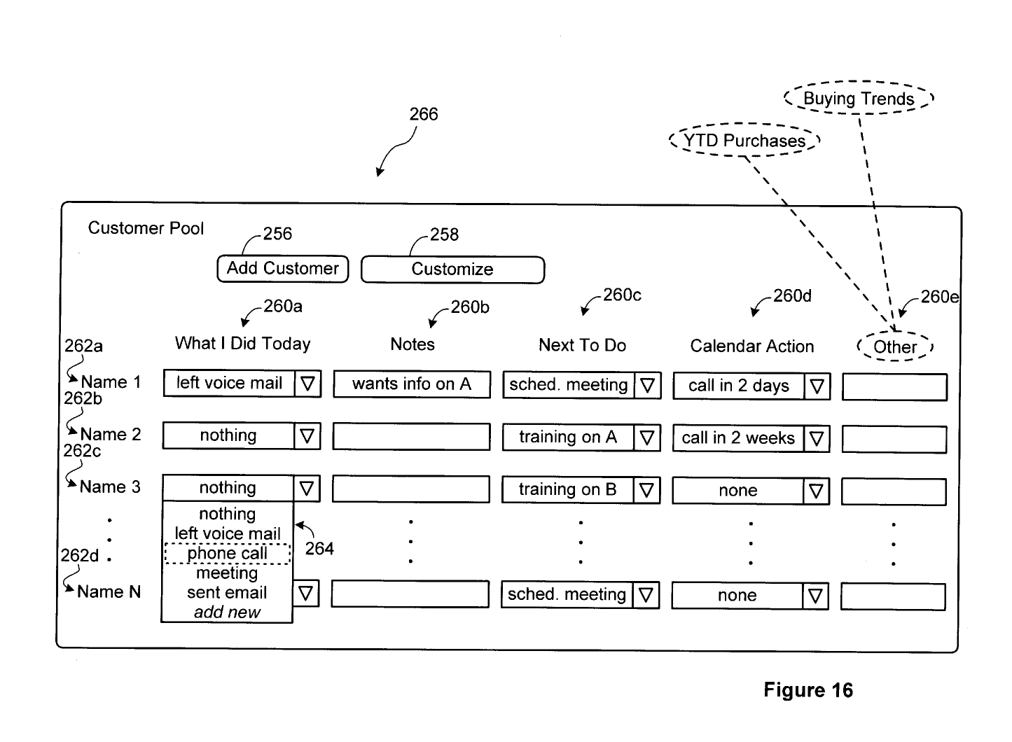

Referring to FIG. 16, in selected embodiments, one or more high level menus 64 or subsequent levels of subcategories 66, 68, 70 may comprise a link or tab taking a user to a page 266 or window 266 comprising data-entry portals relating to a customer pool. This page 266 may provide a mechanism for a user to track customers, plan activities involving specific customers, and the like.

In certain embodiments, the page 266 may include a button 256 to add an individual to the pool, a button 258 to customize the page 266 (e.g., customize the column headings, select which columns to display, etc.), and the like. In selected embodiments, the page 266 may display, for each customer listed 262a, 262b, 262c, etc. various pieces of information 260a, 260b, 260c, etc.

Like the page 254 for a prospect pool, the page 266 for a customer pool may list information regarding what the user did today 260a with respect to the customer, notes 260b, what the user plans to do next 260c with respect to the customer, the date 260d when the next action is to be taken, and the like. Other information 260e that may be included within the page 266 may be a running total of the year-to-date purchases made by the customer, buying trends of the customer, and the like.

Again, in selected embodiments, when a date 260d for a next action 260c is selected, the system 42 may appropriately schedule that action 260c on the user's calendar within the system 42. Accordingly, the system 42 may verify, using one of various methods 192 in accordance with the present invention, whether the action 260c takes place.

Selected pieces of information (e.g., notes 260b) displayed for a customer may be entered or changed by a user as free form text. Other pieces of information (e.g., “What I did Today” 260a) displayed for a customer may be selected or changed using a menu of predefined options, thereby increasing the rate at which data is entered or updated.

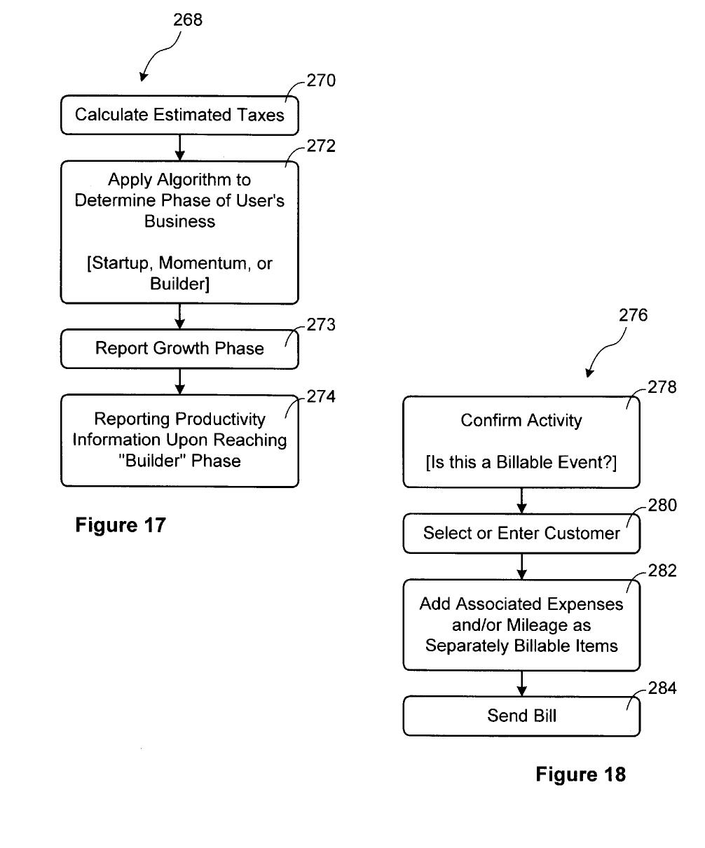

Referring to FIG. 17, in selected embodiments, a system 42 may provide a method 268 for determining the current phase occupied by the user's business. The first step in the method 268 may comprise calculating 270 the estimated taxes for the user's business. While the estimated taxes may not themselves be useful in determining the current phase, the data used in the calculating 270 may also be used to determine the current phase. Accordingly, the determination of the current phase may be an outgrowth of a calculation 270 of estimated taxes.

With the appropriate data collected, the system 42 may apply 272 an algorithm to determine the phase of the user's business. The algorithm may identify expenses and any existing income and compare the two. If the business has only expenses and no revenue, the system 42 may conclude that the business is in startup phase. If the business has earned its first dollar, but still has expenses that exceed the income, the system 42 may conclude that the business is in momentum phase. Finally, if the business has more income than expenses and is making a net profit, the system 42 may conclude that the business is in builder phase. Once the phase has been determined, the system 42 may report 273 the phase to the user.

In the builder phase, the primary emphasis of the business may transition toward productivity. While maximization of tax savings is still important, a new emphasis of the system 42 may be calculating the amount or percentage of “effective” or “productive” time spent on the business. Such productivity calculations may take into account gross income and/or gross income plus tax savings divided by the number of hours spent on the business (or hours spent in some specific aspect of the business such as prospection, closing, etc.). Accordingly, the system 42 may report 274 productivity information to a user once it has been determined that the user's business has entered the builder phase.

Referring to FIG. 18, in selected embodiments, a system 42 may provide a method 276 for invoicing customers. In conjunction with a user confirming 278 or verifying 278 an activity or event (e.g., confirming that the activity took place, entering additional data to fully document the activity, or the like), the system 42 may inquire whether the activity or event corresponds to a billable event. If it does, the user may select 280 or enter 280 the entity to be billed. If there are expenses, mileage, etc. corresponding or linked to the activity, these may be linked to the bill and listed 282 as separate items. The completed bill may be sent 284 immediately (e.g., via email) to the corresponding entity or it may be pooled along with other bills to the same entity to be sent 284 out later, based on settings previously selected by the user.

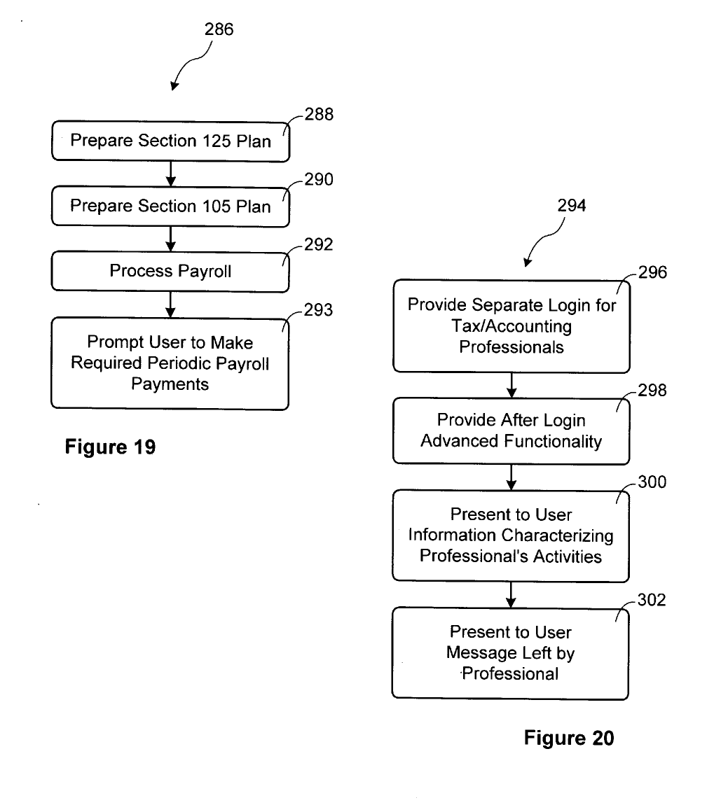

Referring to FIG. 19, in selected embodiments, a system 42 may provide a method 286 enabling a sole proprietor to take full advantage of employing a spouse and deducting medical expenses as employee benefits to the spouse. The system 42 may first assist a user in generating 288 what is referring to in U.S. tax law as a “Section 125 Plan.” The system 42 may assist the user in generating 290 what is referring to in U.S. tax law as a “Section 105 Plan.” Next, the system 42 may set up then process 292 payroll. In certain embodiments, payroll may be set up through a question and answer wizard executed by the system 42 (e.g., by set-up module 47). When the payroll is processed 292, the information generated may be automatically entered into the system 42, thus eliminating the need to re-enter it. Lastly, the system 42 may prompt 293 the user to make the periodic required payroll payments.

In certain embodiments, this method 286 may be applied to employee leasing systems or situations. However, in those embodiments, the method 286 need not include prompting 293 the user to make the periodic payroll payments. In employee leasing, such payments may not be required.

Referring to FIG. 20, in selected embodiments, a system 42 may provide a method 294 enabling professionals (e.g., tax professionals, accounting professionals, etc.) to use the system 42 in support of their clients who are users of the system 42. For example, the system 42 may provide 296 a separate login or “backdoor” for a professional to access his client's account.

Upon logging into the system 42, the professional may be furnished 298 with advanced functionality. For example, the system 42 may provide 298 to the professional a more traditional, “double entry” accounting format that will be familiar to the professional. That is, while the user-side view and features may be designed for simplicity and ease of use by the average business person, the professional-side view and features may support adjusting entries, additional payroll entries, depreciation adjustments, additional reports, and the like. In this way, the system 42 may be a “full power” system 42 without requiring the everyday user to be an accounting expert.

In selected embodiments, the method 294 may continue with the system 42 presenting 300 to the user information characterizing their professional's activities on the system 42 (e.g., when the professional accessed the system 42, what changes were made by the professional, and the like). The method 294 may also include presenting 302 by the system 42 to the user one or more messages left in the system 42 by the professional. Accordingly, the system 42 may provide the professional with an opportunity to give additional instruction to the user.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved.

It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The present invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

What is claimed and desired to be secured by United States Letters Patent is:

1. A system for motivating an individual having a distributorship with a multi-level marketing company to continue the distributorship, the system comprising:
a processor;
a memory device operably connected to the processor;
a computer program stored on the memory device and executable by the processor; and
the computer program comprising
a data module programmed to receive information from the individual,
the data module further programmed to calculate a predicted tax savings, the predicted tax savings quantifying a reduction in tax liability arising from one or more tax deductions associated with the distributorship should the individual have income sufficient to claim the one or more tax deductions, and
an interface module programmed to present the predicted tax savings to the individual.

2. The system of claim 1, wherein the interface module is further programmed to present to the individual a comparison between the predicted tax savings and a predicted cost for the individual to continue the distributorship.

3. The system of claim 2, wherein the predicted cost for the individual to continue the distributorship includes a cost associated with periodic orders of product required by the multi-level-marketing company.

4. A method for motivating an individual having a distributorship with a multi-level marketing company to continue the distributorship, the method comprising:
providing, to the individual, access to a system comprising hardware and software running on the hardware;
receiving, by the system, information from the individual;
using, by the system, the information to calculate a predicted tax savings, the predicted tax savings quantifying a reduction in tax liability arising from one or more tax deductions associated with the distributorship should the individual have income sufficient to claim the one or more tax deductions; and
presenting, by the software system, the predicted tax savings to the individual.

5. The method of claim 4, wherein the presenting comprises comparing the predicted tax savings with a predicted cost for the individual to continue the distributorship.

6. The method of claim 5, wherein the predicted cost for the individual to continue the distributorship includes a cost associated with periodic orders of product required by the multi-level-marketing company.

7. A system for lessening the burden an individual experiences in recording data sufficiently documenting an activity having more than one tax deduction associated therewith, the system comprising:
a processor;
a memory device operably connected to the processor;
a computer program stored on the memory device and executable by the processor; and
the computer program comprising
an interface module programmed to present to the individual a single page simultaneously comprising one or more first data-entry portals and one or more second data-entry portals, the one or more first data-entry portals being configured to receive data corresponding to a financial dimension of the activity, the one or more second data-entry portals being configured to receive data corresponding to a mileage dimension of the activity,
a data module programmed to link new data received through the one or more first data-entry portals with old data previously received through the one or more first data-entry portals, and
the data module further programmed to link new data received through the one or more second data-entry portals with old data previously received through the one or more second data-entry portals.

8. The system of claim 7, wherein the data module is further programmed to receive from a third party financial institution information characterizing the financial dimension of the activity.

9. The system of claim 8, wherein the data module is further programmed to prefill the one or more first data-entry portals with information received from the third party financial institution.

10. The system of claim 9, wherein the data module is further programmed to receive from a GPS application information characterizing the mileage dimension of the activity.

11. The system of claim 10, wherein the data module is further programmed to prefill the one or more second data-entry portals with information received from the GPS application.

12. The system of claim 11, wherein the GPS application is installed on a cellular telephone carried by the individual.

13. The system of claim 7, wherein the single page is a single expandable page that expands or contracts to display more or fewer data-entry portals in accordance with selections input by the individual into the single page.

14. A system for monitoring and reporting an individual's progress toward reaching one or more goals, the system comprising:
a processor;
a memory device operably connected to the processor;
a computer program stored on the memory device and executable by the processor; and
the computer program comprising
a data module programmed to receive data defining a goal,
the data module further programmed to receive data defining an activity of the individual,
the data module further programmed to update a data-set corresponding to the individual with the data defining the activity,
the data module further programmed to calculate from the data-set a current position of the individual with respect to the goal, and
an interface module programmed to present to the individual a comparison between the goal and the current position.

15. The system of claim 14, wherein the interface module is further programmed to present to the individual a page comprising one or more data-entry portals.

16. The system of claim 15, wherein in the data module is further programmed to received through the one or more data-entry portals the data defining the activity.

17. The system of claim 16, wherein the activity has at least one tax deduction associated therewith.

18. The system of claim 7, wherein the data module is further programmed to receive from a third party financial institution information characterizing the financial dimension of the activity.

19. The system of claim 18, wherein the data module is further programmed to receive from a GPS application information characterizing a mileage dimension of the activity.

20. The system of claim 19, wherein the data module is further programmed to prefill at least one of the one or more data-entry portals with information received from the GPS application.
